(19) United States
(12) Patent Application Publication
(10) Pub. No.: US 2026/0163808 A1
(43) Pub. Date: Jun. 11, 2026

(54) INFRASTRUCTURE REPAIR SENSING VIA CONNECTED VEHICLES

(71) Applicant: AT&T Intellectual Property I, L.P., Atlanta, GA (US)

(72) Inventors: Nigel Bradley, Canton, GA (US); Walter Cooper Chastain, Atlanta, GA (US); Sheldon Kent Meredith, Roswell, GA (US); Zhi Cui, Sugar Hill, GA (US)

(73) Assignee: AT&T Intellectual Property I, L.P., Atlanta, GA (US)

(21) Appl. No.: 18/976,487

(22) Filed: Dec. 11, 2024

(51) Int. Cl. H04L 41/149; G08G 1/00; H04W 4/12; H04W 4/38; H04W 4/44

(52) U.S. Cl. CPC H04L 41/149; G08G 1/20; H04W 4/12; H04W 4/38; H04W 4/44

(57) ABSTRACT

Aspects of the subject disclosure may include, for example, receiving, by a processing system including a processor, first sensor data collected at a first time at a location; analyzing, by the processing system, the first sensor data to determine a baseline condition for network equipment at the location; receiving, by the processing system, second sensor data collected at a second time at the location; analyzing, by the processing system, the second sensor data to determine a present condition for the network equipment; comparing, by the processing system, the present condition to the baseline condition to determine a change in the network equipment; and analyzing, by the processing system utilizing Artificial Intelligence (AI) modeling, the change to predict a future time in which the network equipment should be repaired. Other embodiments are disclosed.

### FIELD OF THE DISCLOSURE

The subject disclosure relates to infrastructure repair sensing via connected vehicles.

### BACKGROUND

Service Providers utilize a large amount of infrastructure which requires maintenance. Current maintenance systems and methods often are reactive rather than proactive, and may not adequately address the identification of conditions warranting service or repair, particularly in network infrastructure for telecommunication systems.

Communication Service Providers often operate a large fleet of trucks or other vehicles, creating a significant need for efficient fleet management.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a system functioning within the communication network of FIG. 1 in accordance with various aspects described herein.

FIG. 2C depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for identifying and/or predicting changes in the conditions at a location containing equipment/infrastructure (e.g., communications network equipment) and/or changes to the conditions of the equipment based on the collection of sensor data at multiple points in time. The sensor data can be collected by one or more sensors, which can include a same sensor, different sensors, and/or different types of sensors. In one embodiment, the sensor data being collected at different times can be correlated as to characteristics, such as capturing images at a same time of day at a same orientation so that a comparison and analysis for change is facilitated.

An exemplary embodiment includes collection of visual images of the network equipment location using the same sensor orientation but at different times, for example, to detect changes in the visible conditions of telecommunications infrastructure that may be indicative of damage that needs repair. However, different types of sensors may also be used, such as LiDAR sensors and other sensors to identify changes in the environment that may affect telecom infrastructure performance, such as wireless coverage and/or changes in the conditions of the equipment. By having such a preview visualization of the conditions at the location and/or conditions of the equipment, a repair response may be made to be most efficient.

In one or more embodiments, a system and methodology is provided that can collect visual images and other data at different times to detect changes in the conditions of infrastructure (e.g., telecommunications infrastructure), which may indicate damage requiring repair. This capability can also be used in conjunction with vehicles collecting data and would further enhance proactive fleet management and scheduling.

In one or more embodiments, a system and methodology is provided that utilizes a fleet of vehicles to collect and analyze network conditions including equipment conditions (e.g., damage, excessive wear and tear, etc.). One or more of the exemplary embodiments, provide a convenient and effective technique to identify the need for data collection at specific locations and to assign vehicles for subsequent data collection, such as based on baseline data analysis and trend predictions. In one or more embodiments, a system and methodology is provided for utilizing a same sensor orientation when collecting sensor data (e.g., images) but at different times to detect changes in conditions (e.g., the visible conditions) of infrastructure (e.g., telecommunications infrastructure) that may be indicative of damage that needs repair. In one embodiment, Artificial Intelligence (AI) can assist in proactive management of vehicle fleet planning and scheduling (which can also include on-demand dispatching or on-demand re-routing).

In one or more embodiments, a vehicle fleet can be utilized as a collection of mobile sensors to collect and analyze conditions of a network including its equipment conditions, which in some embodiments can also be utilized in conjunction with other sensors, such as fixed sensors at the network equipment, cameras that capture images at locations (e.g., CCTV or security cameras), drones, sensors on UEs of field technicians, and so forth.

In one or more embodiments, a method and system is provided for determining or predicting changes in the condition of infrastructure (e.g., network equipment) using connected vehicles equipped with various sensors. This can be done based on analyzing sensor data for locations, analyzing sensor data for equipment at the locations, or a combination of both.

In one or more embodiments, the system and methodology provide utilization of connected vehicles as mobile sensors. For example, one or more embodiments can leverage a fleet of vehicles (which may typically be utilized by an entity for other purposes such as service calls at customer premises), which are equipped with sensors such as cameras, LiDAR, radar, and other environmental detectors, to collect data on network infrastructure conditions. This approach transforms the fleet into a mobile sensor network, providing a dynamic and comprehensive method for monitoring network equipment.

In one or more embodiments, the system and methodology provide baseline and subsequent data collection. For example, the system can capture baseline sensor data at an initial time (e.g., t₁) and then collect subsequent sensor data at a later time (e.g., t₂), such as using the same sensor orientation at same location. This allows for precise comparison and detection of changes in the condition of the network equipment.

In one or more embodiments, the system and methodology provide directed and broadcast data collection requests. For example, mechanisms can be provided for sending data collection requests to specific vehicles based on predicted presence at a location or broadcasting requests to multiple vehicles in an area. This ensures that data is collected efficiently and effectively, even in dynamic environments.

In one or more embodiments, the system and methodology provide incident and trend-based data collection. For example, the system can initiate data collection based on known incidents (e.g., storms) and/or trends detected from previous data analysis, including performance data, known conditions of other devices, weather, etc. This proactive approach helps in identifying potential issues before they become critical.

In one or more embodiments, the system and methodology provide AI for analysis and managing repair requests. For example, the collected data is analyzed using AI methods to predict the extent, cause, and/or severity of any detected or determined changes. Based on this analysis, the system can automatically generate repair requests/tickets or take other mitigating actions, streamlining the maintenance process.

In one or more embodiments, the system and methodology provide user interface for driver-occupied vehicles. For vehicles with drivers, the system can include a user interface (e.g., a vehicle communication display) that presents data collection requests and navigation instructions, allowing drivers to participate in the data collection process seamlessly.

These features collectively provide a novel and efficient solution for monitoring and maintaining infrastructure, including by leveraging the mobility and sensor capabilities of connected vehicles.

In one or more embodiments, the system and methodology provide for determining a change in a condition of network equipment that may indicate the need for repair of the network equipment at a location. The method can include receiving, from a first sensor, first sensor data collected at a first time; analyzing the first sensor data; determining, based on the analysis of the first sensor data, a first condition at the location; sending a request to a second sensor to collect second sensor data at a second time at the location; receiving the second sensor data; and determining, based on the analysis of the second sensor data, a second condition at the location, where the second condition is different from the first condition and is indicative of potential disrepair to the network equipment. The sensor data can include data describing or representative of an image. An identity of the second sensor can be determined or selected based on a predicted presence of the second sensor at or near the location at the second time. A time period can be determined between the first time and the second time during which the change in condition occurred. In one embodiment, this information can be utilized for predicting a rate of deterioration and scheduling maintenance to be performed on the equipment. Other embodiments are described in the subject disclosure.

One or more aspects of the subject disclosure include a device comprising a processing system including a processor; and a memory that stores executable instructions that, when executed by the processing system, facilitate performance of operations. The operations can include receiving, from a first sensor, first sensor data collected at a first time at a location, where the first sensor data includes a first image. The operations can include analyzing the first sensor data; determining, based on the analyzing of the first sensor data, a first condition at the location that includes network equipment; and sending a request to a second sensor to collect second sensor data at a second time at the location, where the second sensor data includes a second image. The operations can include receiving, from the second sensor, the second sensor data; analyzing the second sensor data; and determining, based on the analyzing of the second sensor data, a second condition at the location, where the second condition is a change from the first condition. The operations can include analyzing the change to determine that a maintenance action is to be taken for the network equipment.

One or more aspects of the subject disclosure include a method comprising receiving, by a processing system including a processor, first sensor data collected at a first time at a location. The method can include analyzing, by the processing system, the first sensor data to determine a baseline condition for network equipment at the location; and receiving, by the processing system, second sensor data collected at a second time at the location. The method can include analyzing, by the processing system, the second sensor data to determine a present condition for the network equipment; and comparing, by the processing system, the present condition to the baseline condition to determine a change in the network equipment. The method can include analyzing, by the processing system utilizing AI modeling, the change to predict a future time in which the network equipment should be repaired.

One or more aspects of the subject disclosure include a non-transitory machine-readable medium, comprising executable instructions that, when executed by a processing system including a processor, facilitate performance of operations. The operations can include receiving, from a first sensor of a first vehicle, first sensor data collected at a first time at a location, where the first sensor data includes a first image. The operations can include analyzing the first sensor data; and determining, based on the analyzing of the first sensor data, a first condition of network equipment at the location. The operations can include sending a request to a second vehicle to capture a second image. The operations can include receiving, from a second sensor of the second vehicle, second sensor data collected at a second time at the location, where the second sensor data includes the second image. The operations can include analyzing the second sensor data; and determining, based on the analyzing of the second sensor data, a second condition of the network equipment at the location, where the second condition is a change from the first condition. The operations can include analyzing the change to determine that the network equipment is in disrepair.

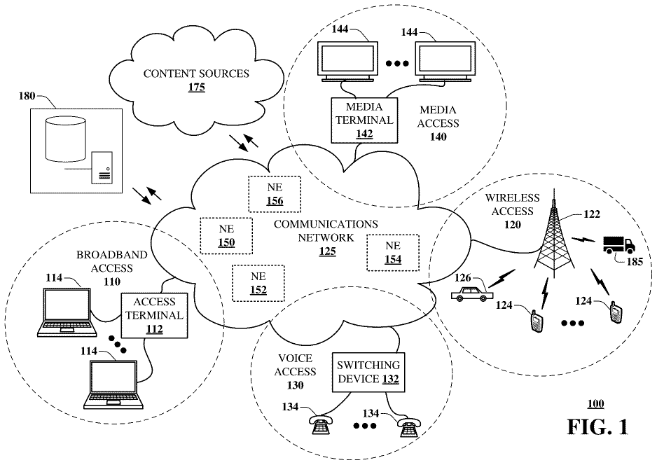

Referring now to FIG. 1, a block diagram is shown illustrating an example, non-limiting embodiment of a system 100 in accordance with various aspects described herein. In the system 100, a maintenance platform 180 and a vehicle(s) 185 can work together to collect both baseline and updated data, including images, to facilitate the analysis and identification of locations and/or network equipment that requires repair. For example, the vehicle 185 can be equipped with various sensors, such as cameras, LiDAR, radar, and other environmental detectors. In one embodiment, the maintenance platform 180 can initiate or otherwise facilitate the process by sending an initialization command to the vehicle 185, activating its sensors to begin the data collection process. In other embodiments, the platform 180 can manage instructions sent to the vehicle 185 for collecting the sensor data, such as navigation commands, time frames, etc. In one embodiment, the vehicle 185 can have a driver who controls the sensor devices and/or the sensor device control can be performed remotely by the platform 180. In one embodiment, the vehicle 185 can be autonomous and the control of the sensor devices can be performed by the vehicle and/or remotely by the platform 180.

At an initial time t₁, the vehicle 185 can navigate to a specific location where network equipment, such as tower 122, is situated. The sensors on the vehicle 185 capture baseline data, including images, spatial data, and/or other environmental parameters. This data is then transmitted to the maintenance platform 180 via the communications network 125. The maintenance platform 180 receives the baseline data and stores it in a database for future reference, performing initial analysis to establish a reference or baseline condition of the network equipment at the location. This baseline condition can include baseline visual characteristics of the equipment, including any damaged/broken structure, rust, discoloration, position (e.g., vertical as opposed to leaning), and so forth. Other information can be used for defining or determining a baseline condition including manufacturer's Specifications.

In one embodiment, based on the analysis of the baseline data or other triggers, such as scheduled maintenance, incident reports, performance parameters, predicted traffic loads, and so forth, the maintenance platform 180 determines the need for updated data collection. For example, the platform 180 can send a request to the vehicle 185 to revisit the location and collect updated data at a subsequent time t₂. In other embodiments, the platform 180 can identify and instruct a different vehicle to capture the updated sensor data for the particular equipment, such as at a particular time or time window. At the subsequent time t₂, the vehicle 185 (or another vehicle) navigates back to the same location. In one embodiment, using the same sensor orientation (e.g., within a threshold such as +/−5 meters and +/−10 degrees of the baseline sensor data orientation) and configuration as during the baseline data collection, the vehicle 185 captures updated data, such as new images and other sensor readings. This updated data can be transmitted back to the maintenance platform 180 via the communications network 125. The maintenance platform 180 receives the updated data and stores it such as alongside the baseline data, performing a comparative analysis between the baseline data (t₁) and the updated data (t₂) to identify any changes in the condition of the network equipment. In other embodiments, the comparative analysis can include predicting future changes or future deterioration to the equipment, which can be utilized for scheduling maintenance for the equipment.

In one embodiment, the maintenance platform 180 uses advanced algorithms, including AI/Machine Learning (ML) techniques, to analyze the differences between the baseline and updated data. For example, the analysis can focus on identifying changes that may indicate potential disrepair, such as physical damage, environmental degradation, or performance issues. If the analysis identifies significant changes indicative of disrepair, the maintenance platform 180 can generate a repair request. The repair request can include detailed information about the identified issues, the location of the network equipment, and/or the specific data supporting the need for repair. The maintenance platform 180 can then send the repair request to the appropriate maintenance team or dispatch center, providing the team with all necessary information to perform the repair. In other embodiments, the maintenance platform 180 can initiate further data collection for the equipment, such as sending a drone that captures closer images of the equipment which can provide more details as to the nature and/or cause of the damage. This collaborative operation between the maintenance platform 180 and vehicle 185 enables continuous and proactive monitoring of network infrastructure, ensuring that any issues are promptly identified and addressed.

For example, system 100 can facilitate in whole or in part receiving first sensor data collected at a first time at a location; analyzing the first sensor data to determine a baseline condition for network equipment at the location; receiving second sensor data collected at a second time at the location; analyzing the second sensor data to determine a present condition for the network equipment; comparing the present condition to the baseline condition to determine a change in the network equipment; and analyzing, utilizing AI modeling, the change to predict a future time in which the network equipment should be repaired.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

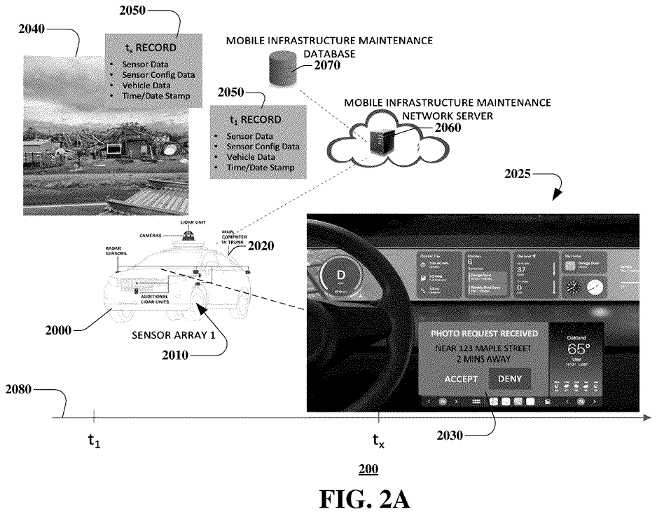

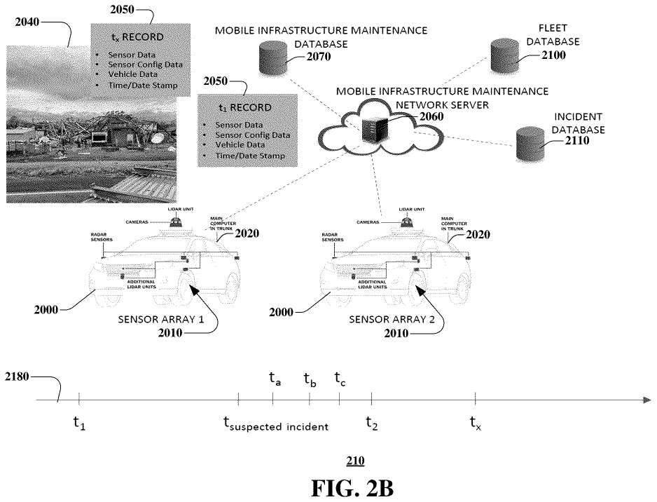

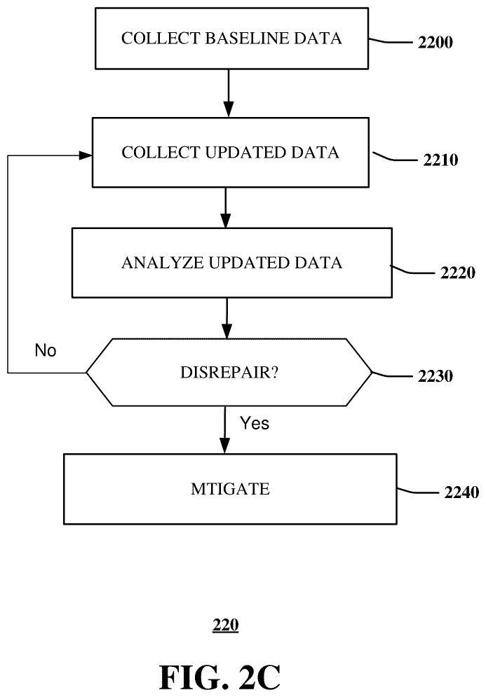

FIG. 2A is a block diagram illustrating an example, non-limiting embodiment of a system 200 functioning within the communication network of FIG. 1 in accordance with various aspects described herein. System 200 provides for infrastructure maintenance (e.g., communication networks) using connected vehicles equipped with various sensors. The system 200 includes one or more vehicles 2000 (only one of which is shown), a sensor array 2010 (which in some embodiments can be an array of the same or different types of sensor(s) or can be a single sensor (e.g., a camera, LiDAR, radar, etc.)) and a sensor computing controller 2020 (which can be a separate computing device or can be integrated with the vehicle computing system such as in an autonomous vehicle). The vehicle 2000 can capture sensor data associated with a location, which is illustrated by reference number 2040. To manage collection of the sensor data and maintenance operations (or portions thereof), the system 200 can include a Mobile Infrastructure Maintenance Network Server (MIMNS) 2060 and Mobile Infrastructure Maintenance Database (MIMD) 2070.

In one embodiment, the sensor array 2010 is mounted on the vehicle 2000 and comprises multiple sensors, including a camera, LiDAR devices, and radar devices. As an example, the camera can capture visual data of the network infrastructure and/or LiDAR devices/radar devices collect spatial data. These sensors work together to gather comprehensive information about the network equipment's condition.

In one embodiment, sensor data can be captured at various times (illustrated by time line 2080 and times t₁, tₓ) and can be recorded or otherwise stored as shown by records 2050 which include other information associated with the sensor data such as configuration data, vehicle data, time/date stamp data.

In one embodiment, a sensor data collection request 2030 can be provided to the vehicle 2000. For example, this request 2030 can be displayed on the vehicle's dashboard 2025, indicating a request for capturing a photo at a specific location. For instance, this request 2030, which can include options for a driver or other user to accept or deny the request, can be generated based on an analysis of previously collected data

In one embodiment, the records 2050 can be stored in the MIMD 2070 for future reference and analysis. MIMNS 2060 processes the data collected by the sensors and/or other available information (e.g., performance data, weather conditions, customer maintenance tickets, etc.) and communicates with MIMD 2070 to store and retrieve records 2050. MIMNS 2060 can also generate requests for additional data collection by the same vehicle 2000 or different vehicles, based on the analysis of the stored records. MIMD 2070 can be used for maintaining a historical record of the network infrastructure's condition and for facilitating trend analysis. In one embodiment, a request is made to collect additional data at time tₓ to compare with the initial data at time t₁, enabling the detection of changes in the network infrastructure's condition. It should be further understood that any number of records (including more than two) can be generated at any number of times (including more than two) for determining condition changes and/or predicting condition changes (including predicting a future time at which the particular network equipment will be in a state of disrepair that has been pre-determined to require mitigation action). In other embodiments, the analysis of the records 2050 by MIMNS 2060 can be utilized for scheduling future data collection (e.g., by vehicle 2000 or another vehicle which can be a collection of sensor data from a same type of sensor such as a camera at a same or similar orientation and distance) for the network equipment.

In one embodiment, system 200 overcomes a lack of a convenient and useful means by which to identify the need for the collection of sensor data that describes the conditions at a specific location and/or conditions of specific network equipment. The system 200 can provide for assigning (or requesting) an autonomous or non-autonomous vehicle 2000 to collect subsequent sensor data based on the analysis of the baseline sensor data (or other collected sensor data) and other known information or predicted information based on trends that occur at the location over a period of time. In an exemplary embodiment, system 200 can perform identification of conditions warranting service or repair, for example, in network infrastructure for telecommunication systems. However, system 200 can apply to other such subject matter analysis.

In one embodiment, system 200 can include or otherwise be configured for collecting other sensor data such as RF interference measurements. For example, spectrum analysis devices can be integrated with or used within the vehicle 2000 to determine RF interference occurring at or near the particular network equipment as shown by reference number 2040. In other embodiments, thermal cameras can be utilized to detect heat emissions of the network equipment. In one embodiment, the sensor data being captured is not limited directly to the network equipment and can include the surrounding area or environment of the network equipment, such as capturing images of objects within a threshold distance of an antenna that might cause interference, such as a rusty fence.

In one embodiment, system 200 can include a first vehicle 2000 (e.g., among a fleet of vehicles which may or may not provide other services for the entity) may be equipped with a sensor or an array of sensors 2010. The sensors 2010 may be one or more types of sensors, for example image capture devices, cameras, video cameras, infrared cameras, LiDAR detectors, radar sensors, motion detectors, and environmental ambient data detectors. In the case of a sensor array 2010, a main computer 2020 on board the vehicle 2000 can serve to collect data from each sensor and/or to send instructions to each sensor for data collection. The vehicle 2000 may be a connected car, or other automotive type vehicle. It may be an autonomous vehicle, or a nonautonomous vehicle. It also may be a drone, robot, or other type of vehicle which either does or does not transport passengers.

In one embodiment, system 200 can include a vehicle(s) 2000 that is in communication over a network via a network node to a mobile infrastructure maintenance server (e.g., MIMNS 2060). The server 2060 can be in communication with a mobile infrastructure maintenance database (e.g., MIMD 2070). This communication may be conducted over a network as well. In the instance of a vehicle 2000 with one or more passengers, there may also exist a user interface 2025 that is controlled by one or more on-board computers that may be used to inform and receive inputs (e.g., notice 2030) from a user in the vehicle concerning the mobile infrastructure maintenance application.

In one embodiment, system 200 can include at time t₁ per time line 2080, a vehicle 2000 capturing data from one or more of its sensors 2010. The vehicle 2000 may be an autonomous or nonautonomous vehicle and the data captured may be data describing an image captured by a camera sensor. The data may be analyzed by the network server 2060 and stored in the network database 2070. This time t₁ record may include sensor data, such as data describing the image collected, also it may include data from the sensor that describes configuration of the sensor, such as the location and directional orientation of the sensor when the data was collected. It may also include data describing the condition of the vehicle 2000, such as the vector direction traveling and speed of travel at the time, and also may include a time and date stamp.

In one embodiment, system 200 can include the mobile infrastructure maintenance network server 2060 tagging the sensor location information and orientation information associated with the t₁ record as being a location of interest. As such, the server 2060 may send a subsequent request to vehicle 2000 (or to another vehicle) to collect sensor data, which can include an instruction to use the same sensor location and orientation data as the time t₁ record to collect sensor data at a subsequent time t₂. This request may be received by vehicle 2000 and the vehicle may create (or be provided with such as from MIMNS 2060) a navigation plan to be at the location of interest at time t₂ to collect the requested data using the same sensor location and orientation as the t₁ sensor data collection. In the same or similar manner or utilizing different techniques, such a request may be directed to a different vehicle.

In one embodiment, system 200 can include the mobile infrastructure maintenance network server 2060 determining that the time of the subsequent data capture is not particularly relevant or vital (or can be performed during a large time window such as over days, weeks or months). Rather, the server 2060 may send a request to a vehicle 2000 that the server predicts will be in the location of the time t₁ record at some future point in time (e.g., within the large time window described above). For example, the network server 2060 may have access to a planned route for vehicle 2000, such as where the vehicle is a field technician truck that is scheduled to visit a particular customer premises within a threshold distance (or passing within a threshold distance) of the location for which the sensor data collection is sought. This planned route may be communicated by the vehicle 2000 and stored in a database (e.g., MIMD 2070), or may be updated to the server 2060 as to its planned route such as in real time or near real time. In either case, the server 2060 knows that vehicle 2000 plans to be in, near or passing by the location at some future time. Vehicle 2000 can store in its own memory this instruction and execute it to collect sensor data at a later time, tₓ. In one embodiment, a notice can be provided to the driver as to the collection of data such as a speed at which to travel or to stop at a particular position at the location.

In one embodiment, in the case of driver-occupied vehicles operating in system 200, the sensor data request 2030 received by the vehicle 2000 may be presented to the driver through a user interface 2025. The user interface 2025 may be a speech related interface, or other interface, or a visual interface (as illustrated in FIG. 2A). The presentation of the request 2030 may indicate that the request has been received along with an approximate location that the vehicle 2000 may determine based on the current location of the vehicle. An estimated time to the destination of the location may also be presented. The driver may be presented with options to either accept or deny the request 2030. Accepting the request 2030 may subsequently include navigation instructions using onboard navigation capabilities of the vehicle 2000. Upon reaching the location at the subsequent time, the sensors on the vehicle 2000 can interpret and act upon the instructions, including capture of the sensor data, using the sensor location, orientation, and other configuration information provided in the request 2030.

FIG. 2B is a block diagram illustrating an example, non-limiting embodiment of a system 210 functioning within the communication network of FIG. 1 in accordance with various aspects described herein. System 210 provides for network infrastructure maintenance using connected vehicles 2000 (two of which are shown) equipped with various sensors.

System 210 can include sensor arrays 2010 mounted on connected vehicles 2000 and can include multiple sensors, including cameras, LiDAR units, radar sensors, thermal cameras, motion sensors, and additional LiDAR units. In one embodiment, these sensors can work together to gather comprehensive information about the network equipment's condition. In other embodiments, types of sensors can be selectively chosen, such as based on the types of network equipment, predicted conditions, weather, historical accuracy of types of sensor data in predicting condition changes, and so forth. Vehicles 2000 can include main computers 2020 that collect data from the sensors and send instructions for data collection.

Records 2050 represent the data collected at different times. For example, the t₁ record includes sensor data, sensor configuration data, vehicle data, and a time/date stamp. In one embodiment, this data can be a baseline for determining condition changes and scheduling future sensor data collection. The tₓ record can be created when subsequent data (e.g., any number of times) is collected to compare with the initial data.

MIMNS 2060 can process the data collected by the sensors and can communicate with various databases (e.g., MIMD 2070) to store and retrieve records. It can also generate requests for additional data collection based on the analysis of the stored records. MIMD 2070 can store all the collected data, including t₁ and tₓ records. It can be used for maintaining a historical record of the network infrastructure's condition and for facilitating trend analysis.

System 210 can include a fleet database 2100 which can contain information about the fleet of vehicles, including their capabilities and sensor configurations. System 210 can include an incident database 2110 which contains data about known incidents, such as storms, accidents, and so forth, which may affect network infrastructure. The server 2060 can analyze this data to determine points of interest for subsequent data collection.

The timeline 2180 represents the sequence of data collection events. At time t₁, initial data is collected and stored. At a later time (e.g., tₓ), a request can be made to collect additional data to compare with the initial data, enabling the detection of changes in the network infrastructure's condition. The timeline 2180 also includes intermediate times tₐ, t_{b}, and t_{c}, which may represent additional data collection points. The suspected incident time (t_{suspected incident}) indicates a point in time when an unknown or unconfirmed incident may have occurred (e.g., a car accident striking the network equipment, a storm, etc.), prompting further data collection.

The system 210 leverages the mobility and sensor capabilities of connected vehicles to monitor and maintain network infrastructure efficiently. By comparing data collected at different times, the system 210 can detect or predict changes in the condition of network equipment and initiate repair requests as needed.

In one embodiment, the system 210 can include the server 2060 identifying a set of vehicles 2000 that are in (or are scheduled to be in) an area surrounding or in proximity to the location of time t₁ record. In this case, the server 2060 may send out a broadcast or multicast request to all such identified vehicles. The server 2060 may further add specificity to the request by assessing the capabilities of the vehicles 2000 that are identified by querying a vehicle inventory database (e.g., fleet database 2100), which may hold data for each such vehicle, for existence of a qualified vehicle within a fleet of vehicles, and may only send the sensor data request to particular vehicles that are equipped with sensors that can satisfy the request. Other factors can be utilized in selecting vehicles, including based on application of AI modeling that improves or optimizes efficiency for selection of vehicles to perform sensor data collection. In one embodiment, a responding vehicle 2000 stores this instruction in its own memory and executes the instruction when it arrives at the location of the record for t₁. The vehicle 2000 returns the requested sensor data (e.g., via a wireless cellular connection with MIMNS 2060 and/or MIMD 2070), and the time tₓ record is created.

In one embodiment, system 210 can include causing collection of a subsequent set of sensor data based on the occurrence of a known incident, such as a storm. There may exist an incident database that contains a set of location data points describing an area of geographical interest within which the incident occurred at a time or over a time period t_{incident}. The server may continually or frequently analyze data from the incident database to determine points of interest that may need a subsequent collection of sensor data. When a point of location within the incident zone corresponds to network infrastructure or other points of interest, the server 2060 may initiate the subsequent sensor data request accordingly.

In one embodiment, system 210 can include server 2060 suspecting or determining, from an analysis of sensor data collected between times t₁ and tₓ, that an unknown or unconfirmed incident may have occurred between t₁ and t₂. For example, the server 2060 may analyze and compare sensor data taken at time t₁ to sensor data with the same location and orientation information at times tₐ, t_{b}, and t_{c}. This comparison may, through analysis of differences in the sensor data at the various times, be an indication of either a point-in-time incident, such as t_{suspected incident}, or a gradual degradation of conditions at the location of interest over a period of time between t₁ and t₂. In either case, this may be an indication to the server 2060 to initiate a request for subsequent data collection for the location at time tₓ.

In one embodiment, system 210 can include the change in condition being determined not by an assessment of the sensor data collected describing the object itself, but rather the surroundings or ambient environment in proximity to the equipment. This type of change in environment sensor data can particularly pertain to other types of sensors as compared to the cameras. For example, a LiDAR detector at time t₁ may detect certain architectural conditions, such as the presence or absence of buildings over a period of time that may change the operating capabilities of proximate network infrastructure at the location of interest. Likewise, sensors may detect changes in electromagnetic radiation, air quality, temperature, noise levels, humidity, or other ambient environment conditions near the location of interest that need to be monitored and therefore the subject of subsequent sensor data collection requests.

In one embodiment, system 210 can provide that upon the detection of a change in sensor data from time t₁ to a subsequent time, the server 2060 may further analyze the subsequent sensor data collected, and predict via AI methods, the extent, cause, and/or severity of the subsequent condition of the network equipment or location, such as the network infrastructure. Accordingly, the mobile infrastructure maintenance network server 2060 may issue a repair request/ticket based on the collected data and analysis of it, and may send a message to a central office or dispatcher to assign one or more parties to the location to perform the repair.

In one embodiment, system 210 can include detecting oscillating repeaters such as on a boat which are creating interference. For example, a vehicle 2000 can have a camera capturing images and a spectrum analyzer detecting interference. In one embodiment, the images captured by the camera can be analyzed to identify/detect oscillating repeaters (e.g., via image pattern recognition) with the assistance of the spectrum analyzer that determines an approximate location and/or direction of the interference and/or interference source.

FIG. 2C depicts an illustrative embodiment of a method 220 in accordance with various aspects described herein. Method 220 provides for determining and mitigating disrepair in infrastructure (e.g., a communications network) using connected vehicles equipped with various sensors. The method 220 can be implemented by a processing system that collects, analyzes, and responds to sensor data to maintain network equipment, such as server 2060. At 2200, the method 220 collects baseline data. This data is gathered from sensors on a connected vehicle(s) at an initial time, providing a reference point for future comparisons. At 2210, the method 220 collects updated data. This data is gathered from the same or different sensors on a connected vehicle(s) at a subsequent time(s), allowing for the detection of changes in the network infrastructure's condition. At 2220, the method 220 analyzes the updated data. The analysis involves comparing the updated data with the baseline data to identify any discrepancies or changes in the condition of the network equipment. At 2230, the method 220 determines whether there is disrepair. This decision point evaluates the analysis results to ascertain if the changes detected indicate potential disrepair in the network infrastructure. At 2240, if disrepair is detected, the method 220 initiates mitigation action(s). These actions involve generating inspection requests and/or repair requests, and taking necessary steps to address the identified issues in the network equipment. If no disrepair is detected, the method 220 may loop back to collect more updated data as needed. For example, any change in condition of network equipment (which may not satisfy a threshold for repair) can be analyzed to determine a future time or time window for collecting future sensor data. In one embodiment, this analysis (in whole or in part) can be performed by AI modeling that can predict a future time when a network equipment condition will be considered in disrepair.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In one or more embodiments, other information can be utilized for determining a baseline condition and/or determining whether a change of condition has occurred for network equipment. For example, a manufacturer's specification or image of a product can be the baseline or can be used in the analysis to detect change. In other embodiments, performance metrics associated with the network equipment can be analyzed to determine potential condition changes, such as detecting interference or measuring performance metrics indicative of interference, and then searching for rust or a loose connection on an antenna or on a linkage to the antenna. In other embodiments, the analysis of the change of condition can result in seeking or requesting collection of other sensor data, for example, detecting a change in a location such as a tree that has fallen and then obtaining additional sensor data such as a close-up image of network equipment to determine if the tree has done damage to the housing of the network equipment.

In one or more embodiments, different types of sensor data collected from different sensors, which can include mobile and fixed sensors, can be used to determine or predict condition changes for network equipment and/or to schedule future sensor data collection, which can include selecting particular vehicles and particular sensors for the future collection.

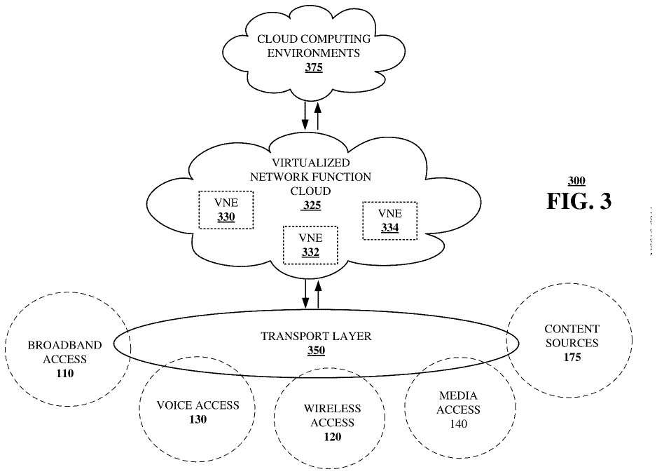

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions described herein. For example, virtualized communication network 300 can facilitate in whole or in part receiving first sensor data collected at a first time at a location; analyzing the first sensor data to determine a baseline condition for network equipment at the location; receiving second sensor data collected at a second time at the location; analyzing the second sensor data to determine a present condition for the network equipment; comparing the present condition to the baseline condition to determine a change in the network equipment; and analyzing, utilizing AI modeling, the change to predict a future time in which the network equipment should be repaired.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads. Various protocols and standards can be applied or serve as guidance for one or more of the exemplary embodiments, including features described with respect to 3GPP Standard, European Telecommunications Standards Institute (ETSI), and so forth.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, User Plane Functions (UPF) and/or Access and Mobility management Functions (AMF), broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

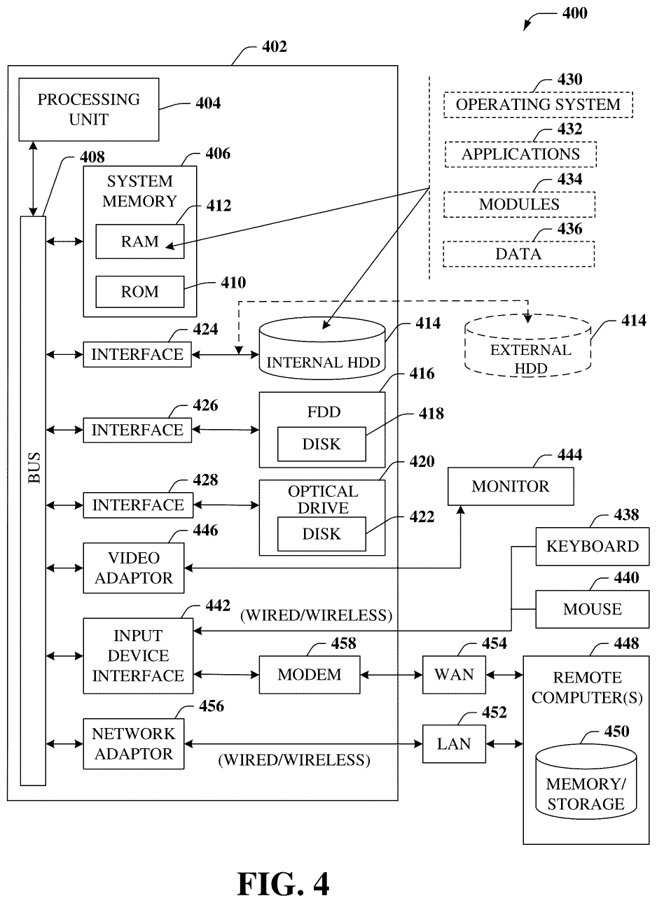

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part receiving first sensor data collected at a first time at a location; analyzing the first sensor data to determine a baseline condition for network equipment at the location; receiving second sensor data collected at a second time at the location; analyzing the second sensor data to determine a present condition for the network equipment; comparing the present condition to the baseline condition to determine a change in the network equipment; and analyzing, utilizing AI modeling, the change to predict a future time in which the network equipment should be repaired.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

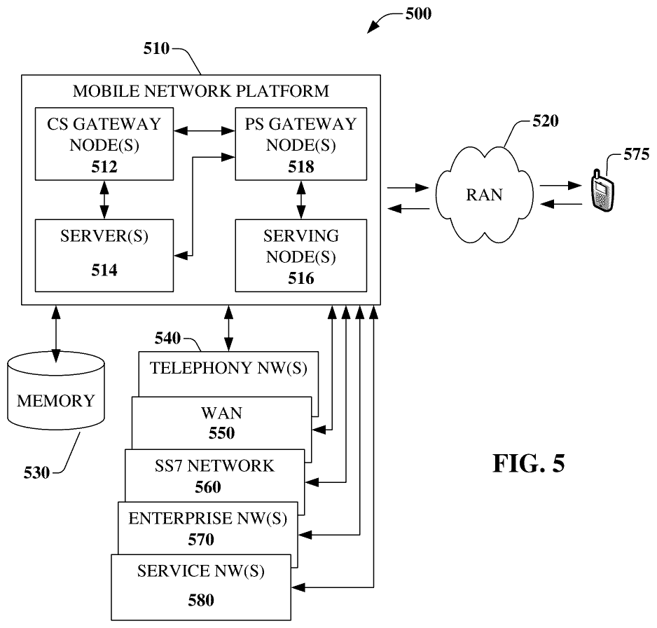

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part receiving first sensor data collected at a first time at a location; analyzing the first sensor data to determine a baseline condition for network equipment at the location; receiving second sensor data collected at a second time at the location; analyzing the second sensor data to determine a present condition for the network equipment; comparing the present condition to the baseline condition to determine a change in the network equipment; and analyzing, utilizing AI modeling, the change to predict a future time in which the network equipment should be repaired.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

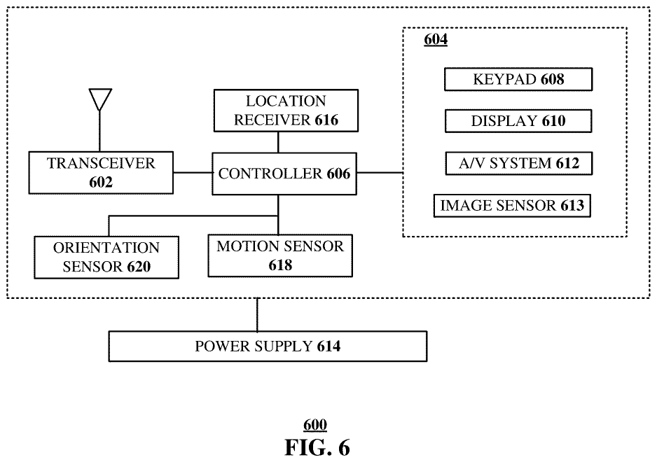

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part receiving first sensor data collected at a first time at a location; analyzing the first sensor data to determine a baseline condition for network equipment at the location; receiving second sensor data collected at a second time at the location; analyzing the second sensor data to determine a present condition for the network equipment; comparing the present condition to the baseline condition to determine a change in the network equipment; and analyzing, utilizing AI modeling, the change to predict a future time in which the network equipment should be repaired.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also AI to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving, from a first sensor, first sensor data collected at a first time at a location, wherein the first sensor data includes a first image;
analyzing the first sensor data;
determining, based on the analyzing of the first sensor data, a first condition at the location that includes network equipment;
sending a request to a second sensor to collect second sensor data at a second time at the location, wherein the second sensor data includes a second image;
receiving, from the second sensor, the second sensor data;
analyzing the second sensor data;
determining, based on the analyzing of the second sensor data, a second condition at the location, wherein the second condition is a change from the first condition; and
analyzing the change to determine that a maintenance action is to be taken for the network equipment.

2. The device of claim 1, wherein the analyzing the change comprises a determination that the network equipment is in disrepair based on:
applying Artificial Intelligence (AI) modeling to generate predicted visual characteristics for the network equipment if it was not in disrepair according to at least one of: a length of time between the first and second times, weather conditions between the first and second times, or a measured amount of usage of the network equipment during the first and second times; and
comparing the predicted visual characteristics to actual visual characteristics extracted from the second image.

3. The device of claim 1, wherein the second sensor is part of a vehicle and wherein the operations further comprise selecting the vehicle from a fleet of vehicle to capture the second image based on a prediction of the vehicle being within a threshold distance of the location at the second time.

4. The device of claim 3, wherein the first sensor is part of another vehicle that is different from the vehicle equipped with the second sensor, and wherein the vehicle and the another vehicle are in wireless communication with the processing system.

5. The device of claim 1, wherein the first and second sensors include at least one of an image capture sensor, an infrared camera, a LiDAR detector, a radar sensor, or an environmental ambient data detector.

6. The device of claim 1, wherein the operations comprise predicting that a vehicle will be within a threshold distance of the location at the second time, and wherein the sending the request to the second sensor comprises sending a message to the vehicle that is equipped with the second sensor.

7. The device of claim 6, wherein the predicting is performed utilizing Artificial Intelligence (AI) modeling that is applied to monitored movement of a fleet of vehicles including the vehicle, wherein the AI modeling is utilized to select particular vehicles for capturing images of particular locations.

8. The device of claim 6, wherein the message is a request that is presented at a display of the vehicle that is equipped with the second sensor, and wherein the operations further comprise receiving an acknowledgement message from the vehicle indicating an acceptance of the request.

9. The device of claim 8, wherein the message is a request to capture the second image wirelessly sent to the vehicle that is equipped with the second sensor, wherein the vehicle is an autonomous vehicle, and wherein the operations further comprise receiving an acknowledgement message from the vehicle indicating an acceptance of the request.

10. A method, comprising:
receiving, by a processing system including a processor, first sensor data collected at a first time at a location;
analyzing, by the processing system, the first sensor data to determine a baseline condition for network equipment at the location;
receiving, by the processing system, second sensor data collected at a second time at the location;
analyzing, by the processing system, the second sensor data to determine a present condition for the network equipment;
comparing, by the processing system, the present condition to the baseline condition to determine a change in the network equipment; and
analyzing, by the processing system utilizing Artificial Intelligence (AI) modeling, the change to predict a future time in which the network equipment should be repaired.

11. The method of claim 10, wherein the analyzing by the AI modeling includes:
applying the AI modeling to generate predicted visual characteristics for the network equipment if it was not in disrepair according to at least one of: a length of time between the first and second times, weather conditions between the first and second times, or a measured amount of usage of the network equipment during the first and second times; and
comparing the predicted visual characteristics to actual visual characteristics extracted from the second sensory data that includes an image.

12. The method of claim 11, comprising:
predicting via the AI modeling that a vehicle will be within a threshold distance of the location at the second time; and
sending a message to the vehicle requesting capturing of the image.

13. The method of claim 12, wherein the predicting is performed utilizing the AI modeling that is applied to monitored movement of a fleet of vehicles including the vehicle, wherein the AI modeling is utilized to select particular vehicles for capturing images of particular locations.

14. The method of claim 12, wherein the message is a request that is presented at a display of the vehicle, and further comprising receiving an acknowledgement message from the vehicle indicating an acceptance of the request.

15. The method of claim 12, wherein the message is a request to capture the image wirelessly sent to the vehicle that is equipped with a sensor for capturing the image, wherein the vehicle is an autonomous vehicle, and further comprise receiving an acknowledgement message from the vehicle indicating an acceptance of the request.

16. The method of claim 10, wherein the first sensor data is captured by a first sensor of a first vehicle, wherein the second sensor data is captured by a second sensor of a second vehicle, and wherein the first and second vehicles are in wireless communication with the processing system.

17. A non-transitory machine-readable medium, comprising executable instructions that, when executed by a processing system including a processor, facilitate performance of operations, the operations comprising:
receiving, from a first sensor of a first vehicle, first sensor data collected at a first time at a location, wherein the first sensor data includes a first image;
analyzing the first sensor data;
determining, based on the analyzing of the first sensor data, a first condition of network equipment at the location;
sending a request to a second vehicle to capture a second image;
receiving, from a second sensor of the second vehicle, second sensor data collected at a second time at the location, wherein the second sensor data includes the second image;
analyzing the second sensor data;
determining, based on the analyzing of the second sensor data, a second condition of the network equipment at the location, wherein the second condition is a change from the first condition; and
analyzing the change to determine that the network equipment is in disrepair.

18. The non-transitory machine-readable medium of claim 17, wherein the operations further comprise:
predicting that the second vehicle will be within a threshold distance of the location at the second time.

19. The non-transitory machine-readable medium of claim 18, wherein the predicting is performed utilizing AI modeling that is applied to monitored movement of a fleet of vehicles including the first and second vehicles, wherein the AI modeling is utilized to select particular vehicles for capturing images of particular locations.

20. The non-transitory machine-readable medium of claim 17, wherein the first and second sensors include at least one of an image capture sensor, an infrared camera, a LiDAR detector, a radar sensor, or an environmental ambient data detector.
